(19) United States
(12) Patent Application Publication
(10) Pub. No.: US 2015/0304020 A1
(43) Pub. Date: Oct. 22, 2015

(54) SELF-CONTAINED MULTIMEDIA INTEGRATED TWO-WAY SATELLITE COMMUNICATION SYSTEM

(71) Applicant: Mohammed Rebec, Riyadh (SA)

(72) Inventor: Mohammed Rebec, Riyadh (SA)

(21) Appl. No.: 13/921,018

(22) Filed: Jun. 18, 2013

Related U.S. Application Data
(60) Provisional application No. 61/662,016, filed on Jun. 20, 2012.

(51) Int. Cl. H04B 7/185; H04W 76/00; G06F 3/0484; H04W 4/02; G06F 3/0481; G06F 3/0482; H04W 4/22; H04W 4/14

(52) U.S. Cl. CPC H04B 7/18528; H04W 4/22; H04W 76/007; H04W 4/14; H04W 4/02; G06F 3/04817; G06F 3/0482; G06F 3/04842

(57) ABSTRACT

A two-way satellite communication system is provided that is particularly suited for use in remote and underdeveloped areas of the world. The system utilizes an icon-based graphical user interface that can be used by illiterate users, as well as portable and renewable power sources for use in remote areas without electrical power. The system can be used to transmit educational/informative materials to populations residing in remote and underdeveloped areas, as well as to provide the means for people in such areas to transmit emergency messages to appropriate organizations/groups. The system preferably utilizes a combination satellite antenna and solar power generator that functions as an omni-directional satellite antenna and an omni-directional solar collector.

### BACKGROUND OF THE INVENTION

This application claims priority to U.S. Provisional Application Ser. No. 61/662,016 filed Jun. 20, 2012, whose entire disclosure is incorporated herein by reference.

1. Field of the Invention

The present invention relates to a two-way satellite communication system and, more specifically, to a two-way satellite communication system that is particularly suited for use in remote and underdeveloped areas of the world.

2. Background of the Related Art

According to a 2003 report by the International Telecommunication Union (ITU), more than 2.5 billion people (approximately 40% of the world's population) live in rural and remote areas of developing countries where access to telecommunications is still very limited. Policy statements and recommendations made by various organizations worldwide have confirmed the need to promote basic telecommunication, broadcasting and the Internet as tools for development in rural and remote areas.

According to the ITU, women and children account for the majority of the population in rural and remote areas of developing countries. In some countries, women account for over 80% of the population in rural and remote areas. Further, many of these rural and remote areas are conflict zones where women and children are particularly vulnerable to abuse. Many women and children in remote conflict zones are trapped and exploited. Many children are kidnapped into soldiering by various militias operating in conflict zones. The absence of telecommunication services in these rural and remote areas prevents the population from requesting outside assistance in the face of these abuses and exploitation. In addition, the lack of telecommunication systems in these rural and remote areas hinders the availability of health services and educational services.

Rural areas encompass a range of geographical terrain, including forest, desert, grasslands, mountain regions and isolated islands. Difficult terrain, combined with poor levels of transport infrastructure increase the cost of establishing, operating and maintaining a telecommunications infrastructure. In addition, in many rural areas services such as electricity are non-existent or insufficient. Further, the high degrees of illiteracy in some rural areas poses another challenge with respect to communicating important information.

### SUMMARY OF THE INVENTION

An object of the invention is to solve at least the above problems and/or disadvantages and to provide at least the advantages described hereinafter.

Therefore, an object of the present invention is to provide a two-way satellite communication system that is self-contained.

Another object of the present invention is to provide a two-way satellite communication system that includes its own power source.

Another object of the present invention is to provide a two-way satellite communication system that includes a renewable power source.

Another object of the present invention is to provide a two-way satellite communication system that utilizes a processor with a graphical user interface.

Another object of the present invention is to provide a two-way satellite communication system that utilizes an icon-based graphical user interface that does not require literacy to operate.

Another object of the present invention is to provide a two-way satellite communication system with multimedia capabilities.

Another object of the present invention is to provide a combination satellite antenna and solar power generator.

Another object of the present invention is to provide an omni-directional cone-shaped satellite antenna that also incorporates a curved base covered with solar panels for generating power.

Another object of the present invention is to provide an omni-directional cone-shaped satellite antenna that also incorporates a toroidal-shaped base covered with solar panels for generating power.

Another object of the present invention is to provide flat panel shaped satellite antenna supported by a spherical housing that is covered with solar panels for generating power.

Another object of the present invention is to provide a telediagnostic health system using a two-way satellite communication system.

Another object of the present invention is to provide an education/information system using a two-way satellite communication system.

Another object of the present invention is to provide an emergency notification system using a two-way satellite communication system.

Another object of the present invention is to provide an intellectual property documentation system using a two-way satellite communication system.

Another object of the present invention is to provide a method for communicating educational or other informational materials to people in remote areas using a two-way satellite communication system.

Another object of the present invention is to provide a method for providing health services to people in remote areas using a two-way satellite communication system.

Another object of the present invention is to provide a method for communicating an emergency condition using a two-way satellite communication system.

Another object of the present invention is to provide a method for documenting intellectual property using a two-way satellite communication system.

To achieve at least the above objects, in whole or in part, there is provided a two-way satellite communication system, comprising a satellite antenna for receiving signals from and sending signals to a satellite, a satellite transceiver in communication with the satellite antenna for modulating a signal to be transmitted to the satellite and for demodulating a signal received from the satellite, a communications station in communication with the satellite transceiver, comprising a processor, processor memory, a display and a communications engine comprising a set of computer readable instructions stored in processor memory that are executable by the processor to: create a graphical user interface (GUI) on the display, display at least one informational icon on the GUI that graphically represents information that has been received from a source via the satellite, show the information that has been received from the source on the display if an informational icon associated with that information has been selected by a user, display at least one action icon on the GUI that graphically represents at least one respective urgent condition, and send a predetermined message regarding an urgent condition to a predetermined destination via the satellite when an action icon associated with the urgent condition is selected by a user.

To achieve at least the above objects, in whole or in part, there is also provided a communications method, comprising creating a graphical user interface (GUI) on a display, displaying at least one informational icon on the GUI that graphically represents information that has been received from a source via satellite, showing the information that has been received from the source on the display if an informational icon associated with that information has been selected by a user, displaying at least one action icon on the GUI that graphically represents at least one respective urgent condition, and sending a predetermined message regarding an urgent condition to a predetermined destination via satellite when an action icon associated with the urgent condition is selected by a user.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to functionally similar elements wherein:

FIGS. 1A and 1B are block diagrams that illustrate the major components of a self-contained two-way satellite communications system, in accordance with one preferred embodiment of the present invention;

FIG. 2A is a schematic diagram showing an example of a graphical user interface that can be generated by the communications station for choosing available content for viewing, in accordance with one embodiment of the present invention;

FIG. 2B is a schematic diagram showing an example of a graphical user interface that can be generated by the communications station that includes an icon for choosing a camera mode, in accordance with one embodiment of the present invention;

FIG. 2C is a schematic diagram showing a hypothetical camera view of a work of art created by an artisan destined to be transmitted to a communications center for registration, in accordance with one embodiment of the present invention;

FIG. 3 is a schematic diagram showing an example of a graphical user interface that can be generated by the communications station for choosing an emergency condition to be communicated to a communications center, in accordance with one embodiment of the present invention;

FIG. 4A is a schematic diagram showing an example of a graphical user interface that can be generated by the communications station that includes an icon for selecting weather information, in accordance with one embodiment of the present invention;

FIG. 4B is a schematic diagram showing a hypothetical weather forecast screen generated in response to a weather icon being selected, in accordance with one embodiment of the present invention;

FIG. 5 is a schematic diagram showing an example of a graphical user interface that can be generated by the communications station for displaying telediagnostics information, in accordance with one embodiment of the present invention;

FIG. 6 is a schematic diagram of a self-contained two-way satellite communication system, in accordance with another embodiment of the present invention;

FIG. 7 is a schematic diagram of a combination satellite antenna/solar power generator that can be used with the self-contained two-way satellite communication system, in accordance with one embodiment of the present invention; and

FIG. 8 is a schematic diagram of a combination satellite antenna/solar power generator that can be used with the self-contained two-way satellite communication system, in accordance with one embodiment of the present invention.

### DETAILED DESCRIPTION OF PREFERRED EMBODIMENTS

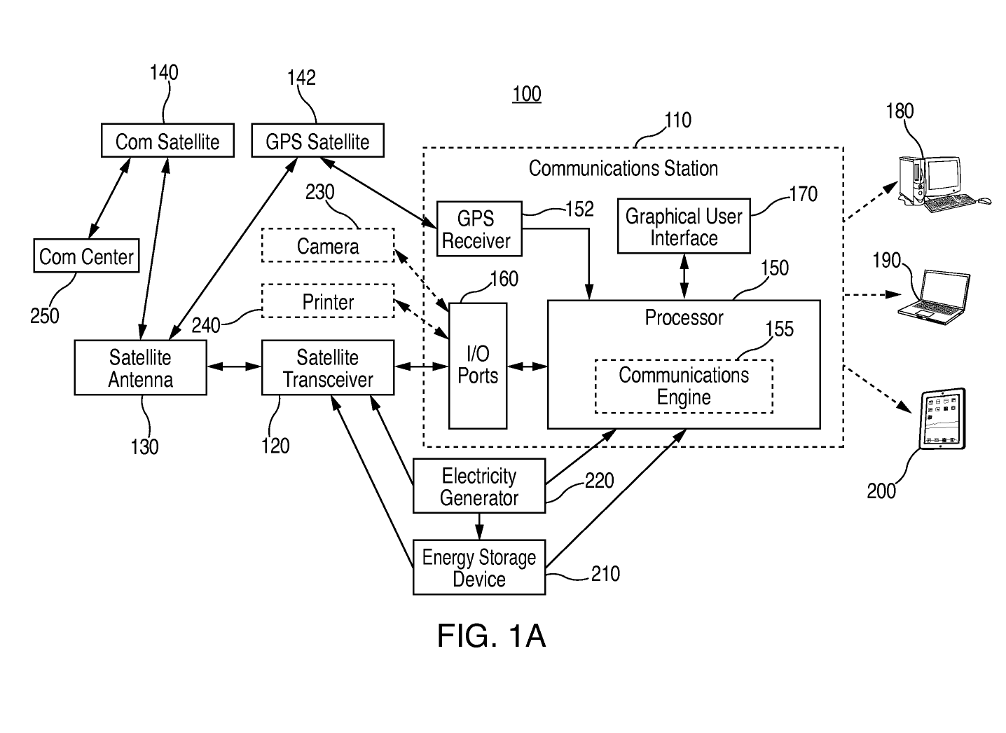

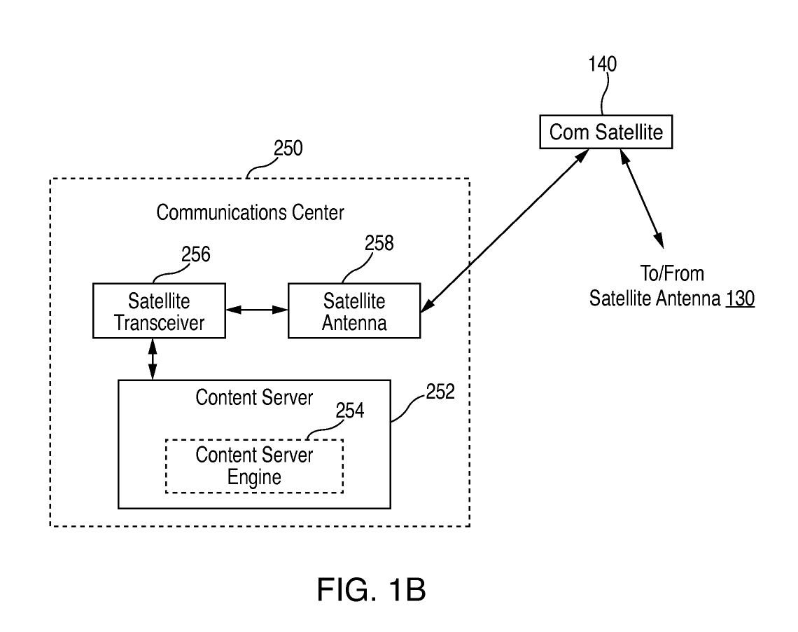

FIGS. 1A and 1B are block diagrams that illustrates the major components of a self-contained two-way satellite communication system 100 that is particularly suitable for use in rural and remote areas, in accordance with one preferred embodiment of the present invention. The system 100 includes a communications station 110, a satellite transceiver 120 in communication with the communications station 110 and a satellite antenna 130 in communication with the satellite transceiver 120 for transmitting signals to and receiving signals from a communications satellite 140.

The satellite antenna 130 can be any satellite antenna known in the art for transmitting and receiving satellite signals from communications satellites, however, it is preferably a high gain full duplex cone-shaped omni-directional antenna with an integrated RF amplifier and integrated power management chips. The satellite antenna 130 preferably also incorporates a GPS receiver (not shown) for receiving GPS signals from GPS satellite 142. A preferred embodiment of the satellite antenna 130 will be described in more detail below.

The communications station 110 preferably includes a processor 150, a communications engine 155 that runs on the processor 150, input/output (I/O) ports 160 for transferring data to and from the processor 150, and a graphical user interface (GUI) 170. A GPS receiver 152 may also be included in the communications station 510 for determining the GPS coordinates (location) of the communications station 110 based on signals from a GPS satellite 142. If a GPS receiver 152 is included in the communications station 110, then the GPS receiver integrated with the satellite antenna 130 can be used as a backup GPS receiver for communicating with the GPS satellite 142, in the event that the GPS receiver 152 in the communication station 510 fails.

The communications engine 155 is preferably implemented with one or more programs or applications run by the processor 150. The programs or applications that implement the communications engine 150 are respective sets of computer readable instructions that are stored in memory (not shown) that are accessed by the processor 150.

The processor 150 and GUI 170 can be implemented with any type of processing device and associated GUI, such as a desktop computer 180, a laptop computer 190 or a tablet computer 200. In general, any device on which a finite state machine capable of running the software used to implement the communications engine 155 can be used as the processor 150.

The GUI 170 is preferably an icon-based GUI that is suitable for use by illiterate users. The GUI 170 is also preferably a touchscreen-based GUI, such as those found on tablet computers, and on some laptop computers and desktop computers. Although the processor 150 and GUI 170 can be implemented with any type of computing device, they are preferably implemented with a tablet computer 200 due to their small size, relatively low power requirements and the relatively easy and intuitive touchscreen-based GUI used by tablet computers. These characteristics of tablet computers make them particularly suited for remote underdeveloped regions and for use by users that are illiterate.

An energy storage device 210, preferably a rechargeable battery, is provided for powering the communications station 110 when there is no electricity infrastructure available. The satellite transceiver 120 can be powered either via a connection to the communications station 110 (e.g., a Universal Serial Bus (USB) connection, an IEEE-1394 (Firewire) connection or other type of connection) or via a direct connection to the energy storage device 210. An electricity generator 220, such as a hand cranked electricity generator, may be provided for recharging the energy storage device 210 and/or for providing power directly to the communications station 110 and/or the satellite transceiver 120.

The system 100 may also include a camera 230 for taking videos and still pictures to be transmitted and a printer 240 for enabling the printing out of hardcopies of information received by the communications station 110. The camera 230, printer 240 and satellite transceiver 120 are preferably connected to the communications station 110 via wired connections to appropriate I/O ports 160, such as an RS-232 serial connection, a Firewire connection, a Fiber Channel connection, a SCSI (Small Computer Systems Interface) connection, a USB connection, an Ethernet connection, an ISDN (Integrated Services Digital Network) line or any other wired, digital or analog interface or connection.

However, camera 230, printer 240 and satellite transceiver 120 may also be connected to the communications station 110 via one or more wireless connections as well, such as a WAP (Wireless Application Protocol) link, a Bluetooth radio link, an IEEE standards-based radio frequency link (WiFi), or any other type of wireless link. A wired connection is preferred, especially in remote underdeveloped areas, because wired connections are more robust, less expensive and use less power then wireless connections.

In operation, a communications center 250 can send information to the communications station 110 via satellite 140. The communications center 250 can be any facility or device with the capability of uplinking data/information to satellite 140. The communications center 250 can be a private or governmental facility/organization. For example, it is envisioned that the system 100 could be used by the United Nations (UN) to transmit information to people in remote underdeveloped regions of the world. In this example, the communications center 250 could be the UN headquarters (HQ) in New York City, U.S.A., and the information sent could be video clips that can educate and instruct broad populations of women and children in practical matters, such as hygiene, nutrition, first aid, small lot farming, animal husbandry, water conservation, self-defense, etc.

FIG. 1B is a block diagram showing details of the communications center 250, in accordance with one preferred embodiment of the present invention. The communications center 250 includes a content server 252, a content server engine 254 that runs on the content server 252. The content server engine 254 is preferably implemented with one or more programs or applications run by the server 252, and preferably stores content received by the communications center 250 from remote areas via communications satellite 140, and also stores content created by designated individuals and/or organizations that will be transmitted to one or more remote areas via communications satellite 140. The programs or applications that implement the content server engine 254 are respective sets of computer readable instructions that are stored in memory (not shown) that are accessed by the content server 252.

The content server 252 is suitably any type of server, such as a Windows server, Linux server, Unix server or the like. However, the content server 252 can be implemented with any type of processing device, such as a general purpose desktop computer, general purpose laptop computer, a special purpose computer, a tablet computer, or a smartphone. In general, any device on which a finite state machine capable of running the software used to implement the content server engine 254 can be used as the content server 252.

The communications center 250 also includes a satellite transceiver 256 and a satellite antenna 258 for uplinking and downlinking satellite signals to/from communications satellite 140. The satellite transceiver 256 can be any satellite transceiver known in the art. The satellite transceiver 256 modulates a carrier signal with data from the content server 252 that is to be uplinked to the communications satellite 140 via satellite antenna 258, and also demodulates incoming satellite signals from the communications satellite 140 and sends the resulting incoming data to the content server 252.

Referring back to FIG. 1A, information from the communications center 250 that has been uplinked to the satellite 140, is then downlinked by the satellite 140 via satellite antenna 130 and satellite transceiver 120. Similar to the satellite transceiver 256 in the communications center 250, the satellite transceiver 120 demodulates the incoming satellite signal from the communications satellite 140 and sends the resulting incoming data to the processor 150 via an appropriate I/O port 160.

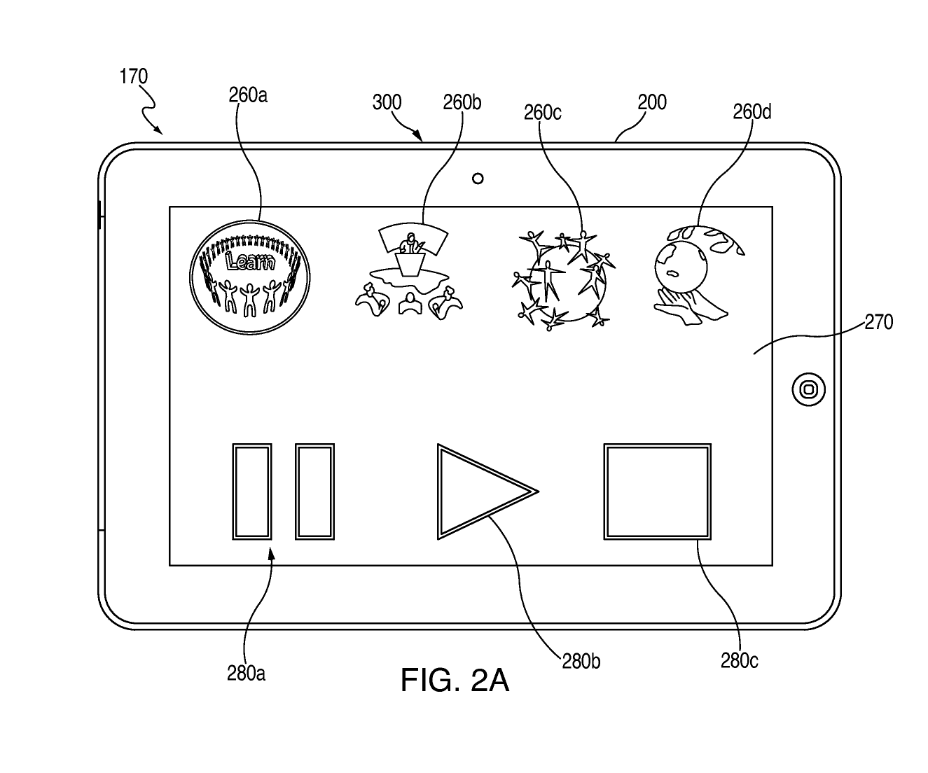

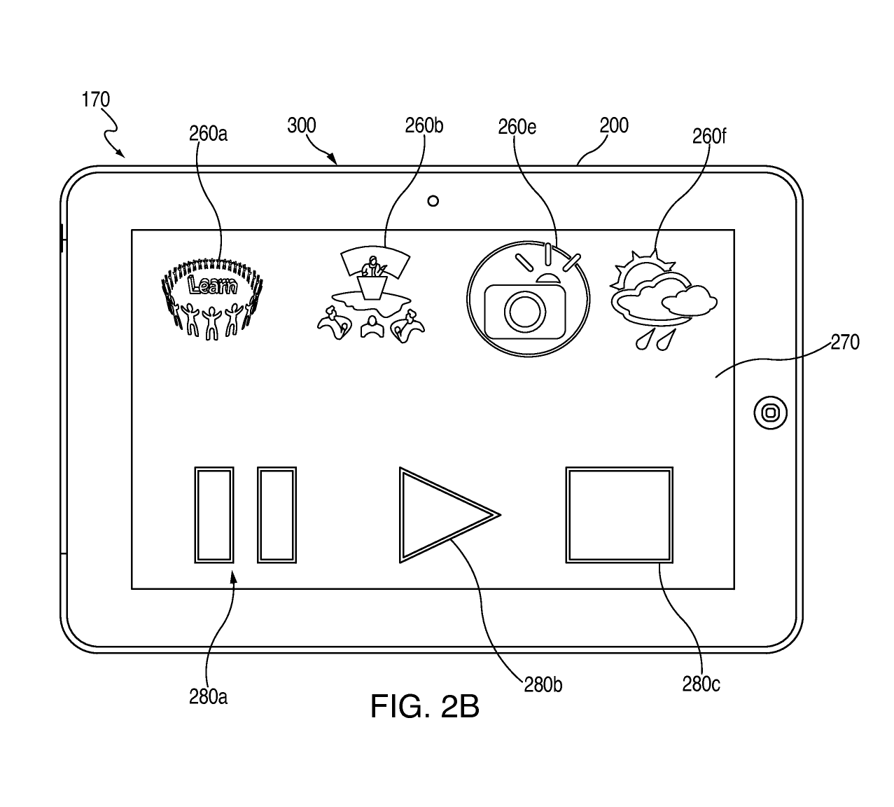

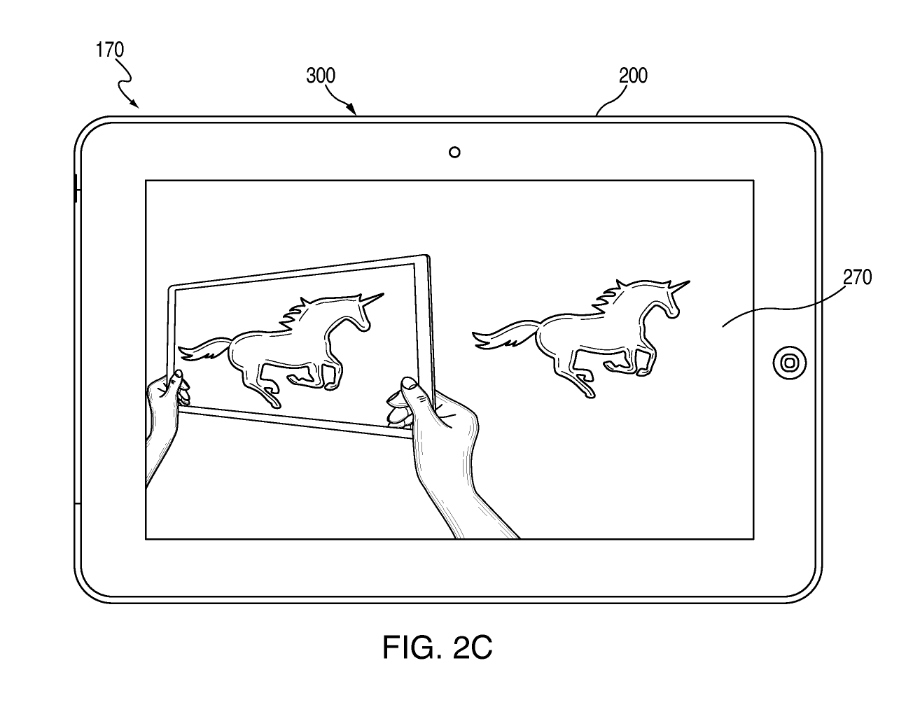

The communications engine 155 displays the received information via the GUI 170, preferably an icon-based GUI that can be understood and used by people that are illiterate. FIG. 2A shows an example of a GUI 170 that can be used by the communications station 110. In the example shown, the communications station 110 is preferably a tablet computer 200. Further, the tablet computer 200 preferably has a built-in camera 300 incorporated into the bezel of the tablet computer 200 for taking pictures and video. Any type of tablet computer known in the art, such as an Apple iPad®, may be used.

Informational icons 260a-260d are used to represent various content that is available for viewing. A user can choose a particular informational icon by touching the tablet's display 270. The GUI 170 may also include control icons 280a-280c. In the example shown in FIG. 2, control icon 280a is for pausing a video, control icon 280b is for playing a video and control icon 280 is for stopping video playback.

In addition to sending information via the system 100 that can educate and instruct broad populations of women and children in practical matters, the system 100 can also be used to help establish and protect intellectual property rights of individuals living in remote underdeveloped areas. The traditional arts and crafts products produced by these populations for sale to the local and tourist markets are increasingly being undercut by overseas mass-produced knock-off imports. To correct this imbalance and safeguard the livelihoods of these marginalized populations, NGOs, such as the International Intellectual Property Institute in Washington, DC, set out to teach the artisans in these areas how to make their arts and crafts products more unique by redirecting their efforts towards art-based products, which could then be copyrighted and trademarked. This new art-based approach would then fetch higher prices in the market place, even as it differentiated and safeguarded their products from imported mass-produced competition.

The system 100 can be used to deliver educational programs related to these intellectual property objectives. Further, the content server 252 in the communications center 250 can be adapted to store photo and video graphed artifacts created by artisans, who use the camera 300 or 230 to take pictures and/or videos of their artifacts and transmit them to the communications center 250 for storage and on-demand access by any interested party, such as art galleries, museums, art magazines, etc. This can help expand the market for the artisans' products.

The communications engine 155 is preferably adapted to monitor and accumulate usage data regarding how many times specific content is being accessed and viewed by the users of the communications system 100 so as to determine statistical information about usage patterns. For example, the communications engine 155 could monitor which educational video clips are being watched and how frequently they are being played. In addition, system 100 could be adapted so that camera 300 and/or an external camera 230 can be remote activated by a designated individual at the communications center 250. This feature can be used to, among other things, identify the sex and age groups of the viewers in real time. Information obtained from this monitoring can help an organization tailor future educational and/or informational video clip programs in a targeted way to more effectively obtain predetermined goals.

As shown in FIG. 2B, a camera icon 260e may be presented as one of the selections available to the user. When the camera icon 260e is selected by the user, the camera 300 in the tablet computer 200 is activated and a picture or video may be taken, as show in FIG. 2C.

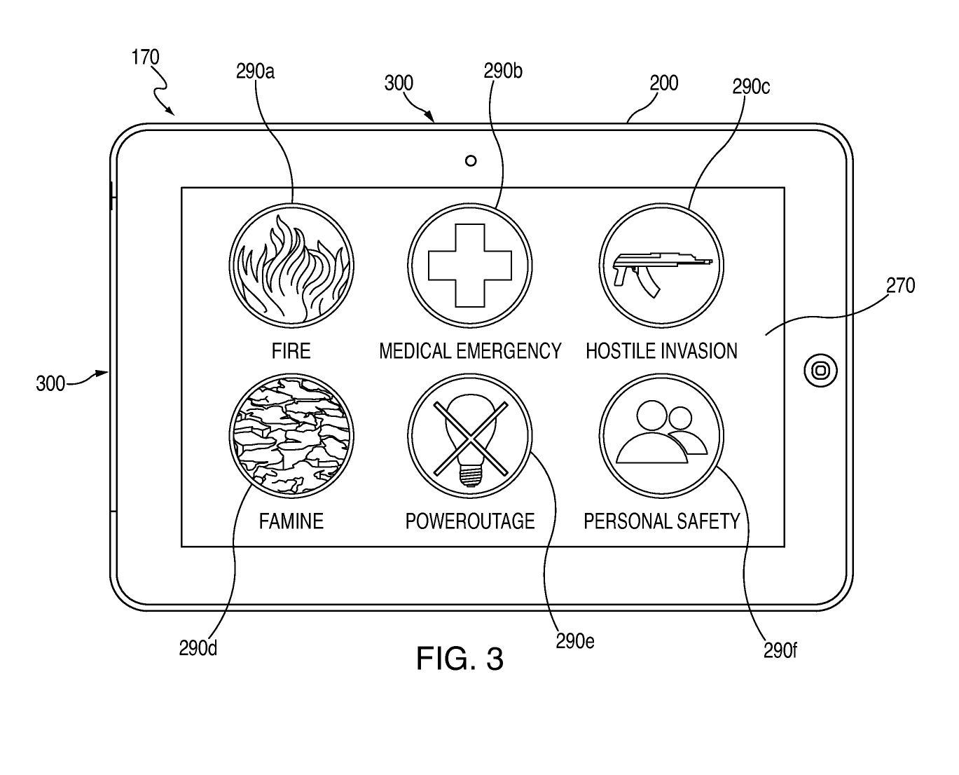

The communications engine 155 preferably provides that ability for users to send urgent messages to the communications center 250 regarding various predefined situations. For example, the communications engine 155 preferably displays an icon-based menu on the GUI 170 that represent various predefined situations, as shown in FIG. 3.

As shown in FIG. 3, the communications engine 155 is capable of displaying action icons 290a-290f representing various emergency situations. Action icon 290a represents fire, action icon 290b represents a medical emergency, action icon 290c represents an invasion by a hostile force, action icon 290d represents a famine condition, action icon 290c represents a power outage and action icon 290f represents any other situation impacting personal safety. These action icons 290a-290f are just a few examples of the type of action icons that can be used. Action icons representing any other situation/condition can be displayed while still falling with the scope of the invention.

In operation, a user would touch the appropriate action icon for the existing situation and a text message would automatically be created and sent to the communications center 250 along with the GPS location of the communications station 110, as determined by the GPS chip 152. The user may optionally create a video message using the camera 300 that can also be transmitted to the communications center 250, along with the text message. However, if satellite bandwidth is limited or if cost considerations require that the size of the transmitted message be kept to a minimum, then the transmission to the communications center 250 is preferably a text only message. Upon receipt of the emergency notification and its originating location, a designated individual can contact the nearest local government, UN or non-governmental organization (NGO) office to investigate.

The camera 300 and communications engine 155 are preferably adapted to allow for the remote control of the camera 300 by a designated individual at the communications center 250 in order to get additional information about the situation that could then be passed on to early response teams. The designated individual can give verbal as well as iconographic instructions to the population via the system 100 until outside help and support arrives. Any user-generated videos received by the communications center 250 are preferably stored in the content server 25 for on-demand access sharing with other NGOs, news organizations or any other entity.

The communications engine 155 in the communications station 110 can also be adapted to provide weather forecasts and information to users in remote areas via the GUI 170. The GPS system (GPS chip 152 and GPS antenna 154) along with detailed maps can, in conjunction with RSS weather forecasts, deliver site-specific detailed weather information to each communications station 110 automatically.

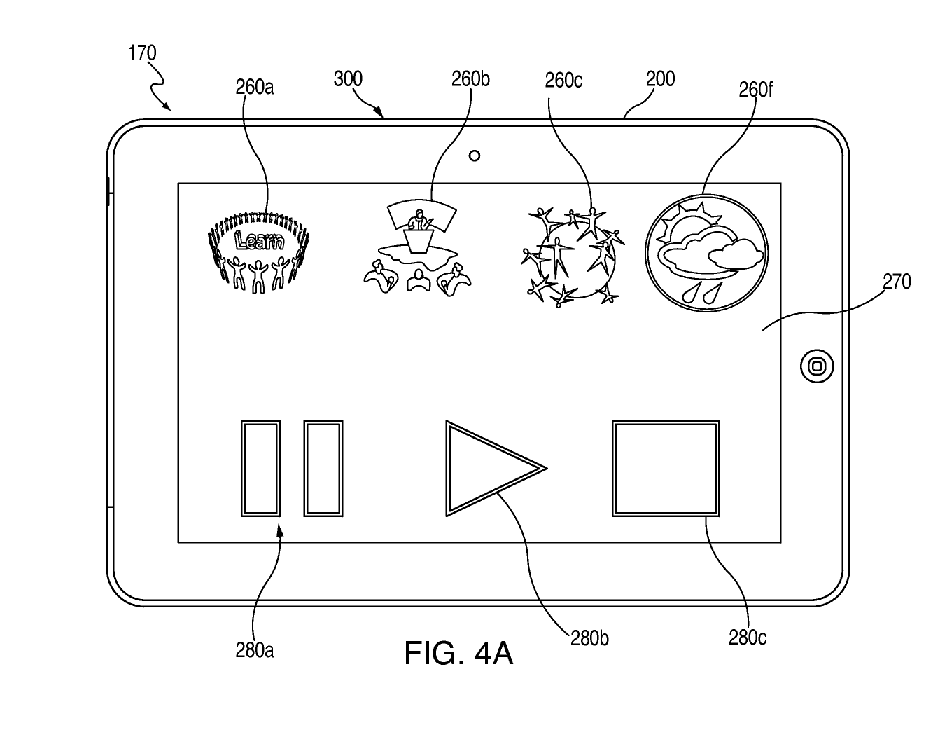

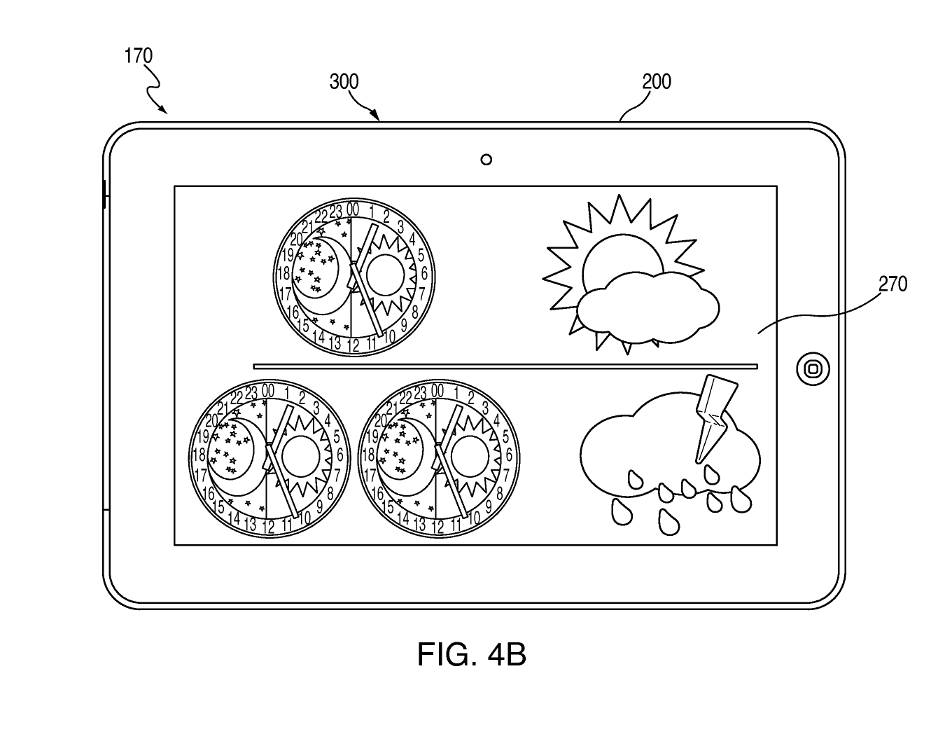

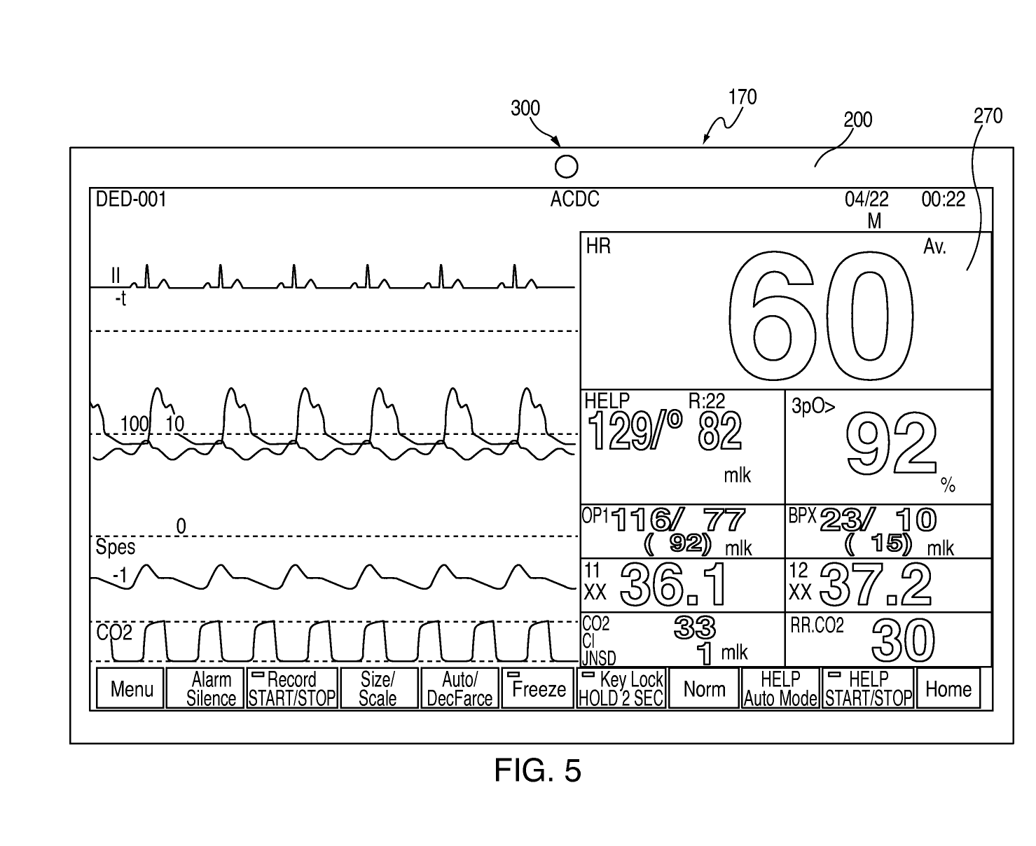

As shown in FIG. 4A, a weather informational icon 260f may be presented as one of the selections available to the user. When the weather informational icon 260f is selected by the user, weather predictions can be displayed on the GUI 170, as shown in FIG. 4B, using graphic symbols for the illiterate. Textual weather information (not shown) may also be provided for the literate. Accurate weather forecasts can constitute very important actionable intelligence for the residents of static and nomadic villages.

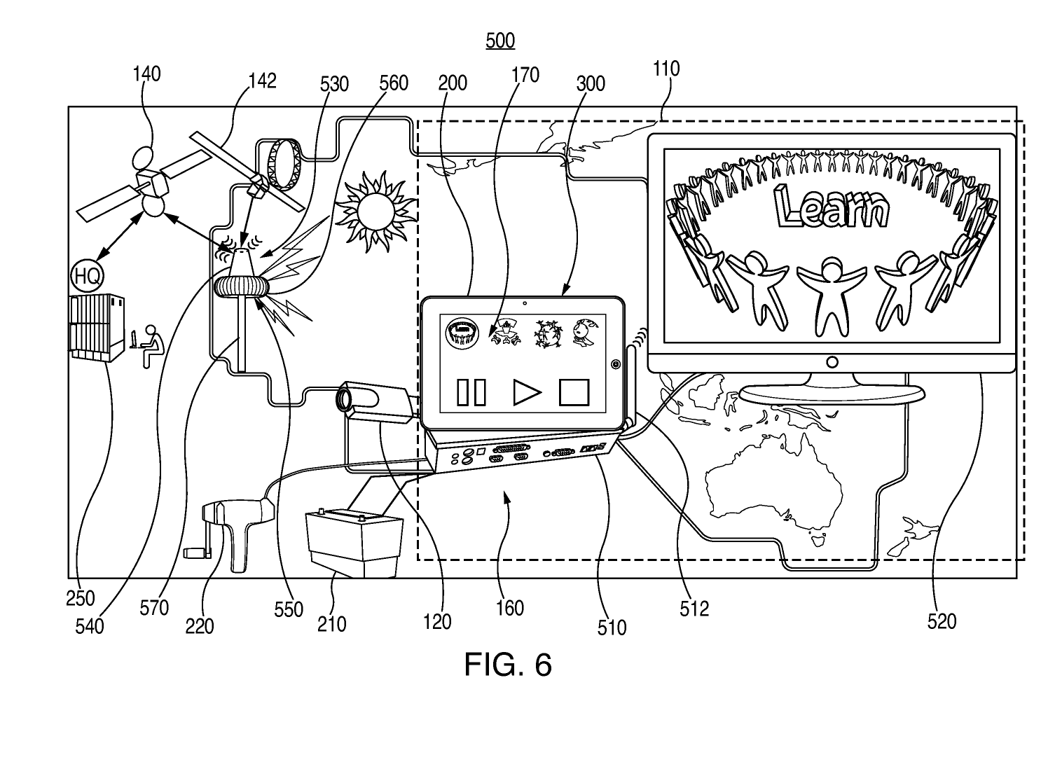

The communications engine 155 in the communications station 110 can also be adapted to provide interactive medical telediagnostics. The I/O ports 160 can include ports for accommodating various types of portable medical diagnostic instruments such as, for example, an electrocardiogram (EKG) unit, a digital stethoscope, a digital thermometer, a digital pulse counter, a digital oximeter, a digital blood pressure monitor, etc. FIG. 6 shows how the telediagnostics information can be displayed on the GUI 170 of the tablet computer 200. Visiting or assigned health professionals at the remote areas can avail themselves of heretofore unreachable expertise at teaching hospitals for help with the diagnosis of complex cases by transmitting the logged test results for evaluation using the system 100.

Additionally, since the communications station 110 can, in conjunction with a full duplex satellite link, enable videoconferencing, specialists can participate “live” in the ongoing patient diagnosis using the system 100. Finally, national and international health outreach programs can incorporate the field information and statistics generated by these portable mini clinics to improve the overall delivery of their health outreach programs.

If the availability of satellite bandwidth is limited or the cost for accessing such bandwidth is restrictive, then the communications engine 160 can be adapted to control when and how often information is downlinked from and uplinked to the communications satellite 140. The cost of accessing privately owned communications satellite can vary based on peak usage periods. The communications engine 155 can be adapted to schedule uplinks and downlinks during periods of low usage, which is typically less expensive than during peak usage periods. For example, the communications engine 160 can be adapted to transmit load-driven traffic density probe “pings” in order to determine optimal uplink conditions. The uplinks can be dynamically packetized in order to be able to uplink large files in segmented bursts over a period of time.

FIG. 6 is a schematic diagram of a self-contained two-way satellite communication system 500, in accordance with another preferred embodiment of the present invention. The system 500 is similar to system 100 of FIGS. 1A and 1B, and like reference numerals refer to functionally similar elements. The communications station 110 preferably includes a tablet computer 200 that incorporates a processor 150 (not shown in this figure) that runs the communication engine 155 (not shown in this figure), a docking station 510 that contains multiple I/O ports 160 as well as an internal battery (not shown) for powering ports that require power and for providing additional power for the tablet computer 200. The docking station 510 may also include a WiFi chip (not shown) and a WiFi antenna 512 transmitting and receiving WiFi signals. The docking station 510 is adapted to connect to the tablet computer 200 so that the I/O ports 160 of the docking station 510 can be accessed by the tablet computer 200 and so that the internal battery of the docking station 510 can be used providing additional power to the tablet computer 200.

The system 500 preferably includes an external display 520 for displaying the content that is chosen by a user via the tablet computer 200. In this configuration the tablet computer 200 could display a menu of available content/options on its GUI 170, and when a user chooses a particular piece of content, the content itself would be displayed on the external display 520. This configuration would allow for video playback control via the tablet computer 200 while the video plays on the external display 520. The external display 520 is connected to the tablet computer 20 via the docking station 510 and receives power via an electrical outlet (when available) or via the internal battery of the docking station 510 when an electrical outlet is not available.

A combination satellite antenna/solar power generator 530, which will be explained in more detail below, is preferably used that includes a cone-shaped omni-directional antenna 540 that is attached to a base 550 having a curved surface, preferably a toroidal-shaped base, onto which solar panels 560 are attached. The solar panels 560 are used for generating electricity that can be used to power the docking station 510, and thus the tablet computer 200 and external display 520, as well as to recharge the energy storage device 210. The combination satellite antenna/solar power generator 530 thus functions as both an omni-directional satellite antenna and an omni-directional solar collector. A support post 570 is preferably attached to the base 550 that can be inserted into the ground so that the combination satellite antenna/solar power generator 530 is suspended above the ground. The solar panels 560 on the base 550 are able to capture direct sunlight as well as sunlight reflected off the ground due to the curved surface of the base 550. Alternatively, as will be explained in more detail below, a flat panel satellite antenna embedded within a spherical solar power generator can be used that would allow for greater antenna gain in weak signal areas without compromising electricity generating functions.

The energy storage device 210, preferably a battery, provides supplemental power to the docking station 510, and thus to the tablet computer 200 and external display 520. An electricity generator 220, such as a hand crank electricity generator, is preferably provided for providing power to the docking station 510 when the energy storage device 210 and the internal battery in the docking station 510 have been depleted and when solar power from the solar panels 560 is not available. The electricity generator 220 can also be used to recharge the energy storage device 210, the internal battery in the docking station 510 and/or the internal battery in the tablet computer 200. The I/O ports 160 of the docking station 510 are used to connect the external display 520, satellite transceiver 120, energy storage device 210, electricity generator 220 and any other peripherals, such as printers (not shown), external cameras (not shown) and telediagnostics devices (not shown), to the tablet computer 200.

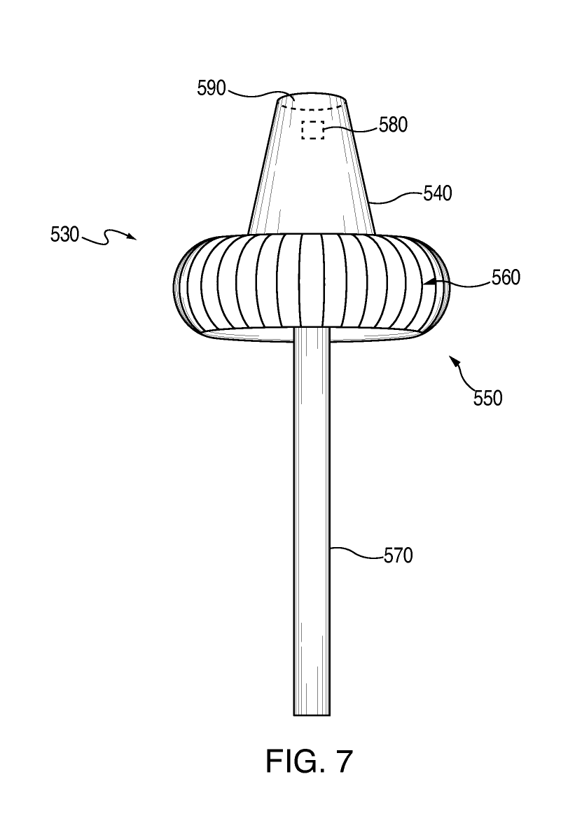

FIG. 7 is a schematic diagram of the combination satellite antenna/solar power generator 530, in accordance with one embodiment of the present invention. The combination satellite antenna/solar power generator 530 preferably includes a cone-shaped omni-directional satellite antenna 540, preferably a full duplex high gain antenna with an integrated RF amplifier (not shown) and integrated power management. The cone-shaped satellite antenna 540 preferably includes a cap 590 that attaches to the top of the cone-shaped antenna 540. A GPS receiver 580 is preferably positioned inside the cone-shaped antenna 540 just below the cap 590 for receiving GPS signals from GPA satellites. The cap 590 is preferably made of a material that is at least partially transparent to GPS signal frequencies.

The satellite antenna 540 is attached to a base 550 having a curved surface, preferably a toroidal-shaped base. The base 550 is suitably a hollow frame made of any type of suitable material, but preferably a composite material. Examples of suitable composite materials include, but are not limited to, fiberglass, quartz-based composites and aramid fibers (e.g., Kevlar®). Solar cell panels 560 are attached to the surface of the base 550. The solar cell panels 560 are preferably flexible solar arrays that can bend to conform to the curvature of the surface of the base 550. Any type of flexible solar array known in the art may be used, however, the number and type of solar arrays used for the solar panels 560 are preferably such that they collectively supply at least 25 watts per hour at a voltage of approximately 13.5 volts in full sunlight.

A support post 570 is preferably attached to the base 550 and can be inserted into the ground so that the combination satellite antenna/solar power generator 530 is suspended above the ground. The base 550 is preferably shaped such that the solar cell panels 560 that are attached to the surface of the base 550 collect direct sunlight, as well as sunlight that reflects off the ground when the base 550 is suspended off the ground. To this end, the base 550 is preferably toroidal-shaped. The power generated by the solar cell panels 560 is preferably used to power the electronics for the satellite antenna 540, and may also be used to supply power to the docking station 510, energy storage device 210 and satellite transceiver 120.

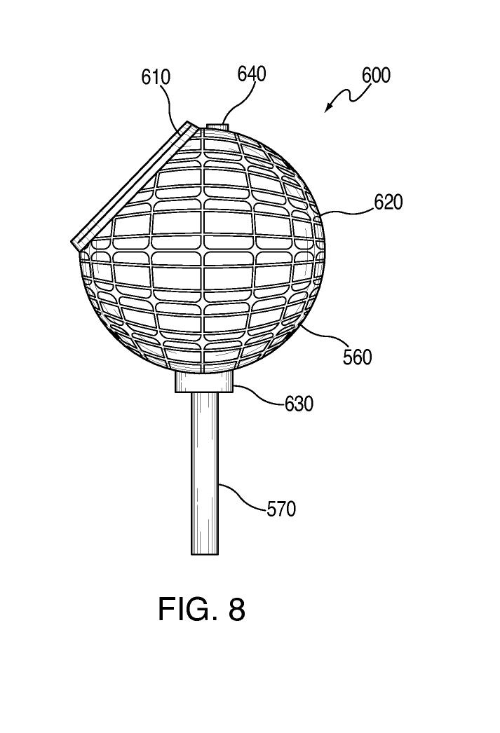

FIG. 8 is a schematic diagram of a combination satellite antenna/solar power generator 600 that can be used in place of the combination satellite antenna/solar power generator 530 of FIGS. 6 and 7, in accordance with one embodiment of the present invention. The combination satellite antenna/solar power generator 600 preferably includes a flat panel satellite antenna 610 that is mounted in a spherical-shaped housing 620. Solar panels 560 are attached to the surface of the spherical-shaped housing 620.

The solar cell panels 560 are preferably flexible solar arrays that can bend to conform to the curvature of the surface of the spherical-shaped housing 620. Any type of flexible solar array known in the art may be used, however, the number and type of solar arrays used for the solar panels 560 are preferably such that they collectively supply at least 25 watts per hour at a voltage of approximately 13.5 volts in full sunlight.

The flat panel satellite antenna 610 allows for greater antenna gain in weak signal areas than you can typically achieve with omni-directional antennas. Thus, the flat panel satellite antenna 610 is particularly suited for Ku band satellite signals, which are more sensitive to atmospheric conditions due to their higher frequency (typically 12-18 GHz). However, any type of flat panel satellite antenna known in the art may be used.

The spherical housing 620 is preferably a hollow housing made of any type of suitable material, but preferably a composite material. Examples of suitable composite materials include, but are not limited to, fiberglass, quartz-based composites and aramid fibers (e.g., Kevlar®). The electronics associated with the flat panel antenna 610 are housed within the spherical-shaped housing 620.

A support post 570 is preferably attached to the spherical housing 620 and can be inserted into the ground so that the combination satellite antenna/solar power generator 620 is suspended above the ground. Because of the shape of the spherical housing 620, the solar cell panels 560 that are attached to the surface of spherical housing 620 collect direct sunlight, as well as sunlight that reflects off the ground when the spherical housing 620 is suspended off the ground. The power generated by the solar cell panels 560 is preferably used to power the electronics for the satellite antenna 540, and may also be used to supply power to the docking station 510, energy storage device 210 and satellite transceiver 120.

Because the flat panel satellite antenna 610 is directional, the support post 570 is preferably attached to the spherical housing 620 using a mount 630 that allows for adjustment of the azimuth angle as well as the altitude or zenith angle. Such mounts are known in the art as altazimuth or alt-azimuth mounts, and any such mount known in the art can be used. A GPS antenna 640 is preferably positioned on top of the spherical housing 620 for receiving GPS satellite signals.

The foregoing embodiments and advantages are merely exemplary, and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. Various changes may be made without departing from the spirit and scope of the invention, as defined in the following claims. For example, although many of the examples discussed utilized a tablet computer 200 for the processor 150 and GUI 170, any other type of computing apparatus, such as a desktop computer, laptop computer or others, can be used as the processor and GUI 170.

What is claimed is:

1. A two-way satellite communication system, comprising:
a satellite antenna for receiving signals from and sending signals to a satellite;
a satellite transceiver in communication with the satellite antenna for modulating a signal to be transmitted to the satellite and for demodulating a signal received from the satellite;
a communications station in communication with the satellite transceiver, comprising,
a processor;
processor memory;
a display; and
a communications engine comprising a set of computer readable instructions stored in processor memory that are executable by the processor to:
create a graphical user interface (GUI) on the display;
display at least one informational icon on the GUI that graphically represents information that has been received from a source via the satellite,
show the information that has been received from the source on the display if an informational icon associated with that information has been selected by a user,
display at least one action icon on the GUI that graphically represents at least one respective urgent condition, and
send a predetermined message regarding an urgent condition to a predetermined destination via the satellite when an action icon associated with the urgent condition is selected by a user.

2. The system of claim 1, wherein the information received from the source comprises educational information.

3. The system of claim 1, wherein the information received from the source comprises weather forecasts.

4. The system of claim 1, wherein the at least one respective urgent condition comprises at least one of a fire, a medical emergency, a hostile invasion, a famine and a power outage.

5. The system of claim 1, wherein the predetermined message sent in response to the user selecting an action icon comprises a text message identifying the urgent condition.

6. The system of claim 5, wherein the communications station further comprises a GPS receiver for communicating with a GPS satellite, and wherein the predetermined message further comprises the GPS coordinates of the communications system.

7. The system of claim 5, further comprising a camera in communication with the communications station, and wherein:
a picture or video of a predetermined length is taken by the camera in response to the user selecting an action icon; and
the predetermined message sent in response to the user selecting an action icon further comprises the picture or video.

8. The system of claim 1, further comprising an energy storage device for providing power to the communications station.

9. The system of claim 8, wherein the energy storage device comprises a rechargeable battery.

10. The system of claim 9, further comprising an electricity generator for providing power to the communications station and/or recharging the rechargeable battery.

11. The system of claim 10, wherein the electricity generator comprises a hand-cranked electricity generator.

12. The system of claim 1, wherein the satellite antenna comprises:
a base having a curved surface;
a cone-shaped satellite antenna attached to the base; and
at least one solar cell panel attached to the curved surface of the base, wherein the at least one solar cell panel is flexible so as to conform to the curved surface of the base.

13. The system of claim 12, wherein the base is toroidal-shaped.

14. The system of claim 12, further comprising a support post attached to the base for supporting the base and cone-shaped satellite antenna above ground level.

15. The system of claim 1, wherein the communications station further comprises at least one input/output port for connecting at least one diagnostic instrument, and wherein the communications engine comprises a set of computer readable instructions stored in processor memory that are executable by the processor to:
display data from the at least one diagnostic instrument on the GUI, and
send the data from the at least one diagnostic instrument to a predetermined destination via the satellite.

16. The system of claim 15, wherein the at least one diagnostic instrument comprises at least one of an electrocardiogram (EKG) unit, a digital stethoscope, a digital thermometer, a digital pulse counter, a digital oximeter and a digital blood pressure monitor.

17. The system of claim 1, wherein the communications unit comprises a tablet computer.

18. A communications method, comprising:
creating a graphical user interface (GUI) on a display;
displaying at least one informational icon on the GUI that graphically represents information that has been received from a source via satellite;
showing the information that has been received from the source on the display if an informational icon associated with that information has been selected by a user;
displaying at least one action icon on the GUI that graphically represents at least one respective urgent condition; and
sending a predetermined message regarding an urgent condition to a predetermined destination via satellite when an action icon associated with the urgent condition is selected by a user.

19. The method of claim 18, wherein the predetermined message comprises information identifying the urgent condition and the GPS coordinates of the user.

20. The method of claim 18, wherein the at least one respective urgent condition comprises at least one of a fire, a medical emergency, a hostile invasion, a famine and a power outage.
